(19) United States
(12) Patent Application Publication
(10) Pub. No.: US 2025/0023020 A1
(43) Pub. Date: Jan. 16, 2025

(54) COMPOSITE ELECTRODE MATERIAL, METHOD FOR ITS PRODUCTION AND USE OF THE MATERIAL

(71) Applicant: LEYDENJAR TECHNOLOGIES B.V., Leiden (NL)

(72) Inventors: Joris Pieter Valentijn MAAS, Leiden (NL); Rohanraj SIVARAJ, Leiden (NL); Tijmen Rudolf GEERTSEN, Leiden (NL); Yiseop AHN, Leiden (NL); Arjen Peter DIDDEN, Leiden (NL)

(21) Appl. No.: 18/713,429

(22) PCT Filed: Dec. 1, 2022
(86) PCT No.: PCT/NL2022/050691

§ 371 Date: May 24, 2024

(30) Foreign Application Priority Data
Dec. 1, 2021 (NL) 2029989

(51) Int. Cl. H01M 4/36; H01M 4/02; H01M 4/04; H01M 4/134; H01M 4/38; H01M 4/66

(52) U.S. Cl. CPC H01M 4/366; H01M 4/0404; H01M 4/134; H01M 4/386; H01M 4/661; H01M 2004/021

(57) ABSTRACT

A composite electrode material, method for its production and use of the material are provided. The composite electrode material comprises: i) a current collector material layer exhibiting a surface roughness value selected from at least one of the following: —an Sdr value of more than 40%; and —an Sdq value of more than 1.0; each value being determined by white light interferometry according to standard method ISO 25178; ii) optionally, a first silicon layer positioned on the current collector material layer, wherein the first silicon layer has a porosity of less than 30%, as determined by electron microscopy; and iii) at least a second silicon layer positioned on either the optional first silicon layer or the current collector material layer, wherein the second silicon layer has a porosity ranging from a porosity higher than the porosity of the optional first layer, to a porosity of less than 80%, as determined by electron microscopy.

### FIELD OF THE INVENTION

The present invention relates to a composite electrode material comprising a current collector material layer exhibiting certain surface properties, and one or more silicon layers deposited thereon, a method for producing the composite material, a battery comprising the composite material and use of the composite material.

### BACKGROUND OF THE INVENTION

Lithium-ion batteries are widely used as rechargeable energy storage systems for many devices. They mainly consist of two electrodes, a separator and electrolyte. During charging lithium ions are released from the cathode and move toward the anode, forming an interaction with the active material of the anode. During discharging this is reversed enabling the release of electrons from lithium atoms in the anode, which provides electrical power.

Silicon is an attractive active anode material as it possesses a very high theoretical capacity (4200 mAh/g) and can intercalate 4.4 Li into Si. A disadvantage of silicon anodes is the very high volume expansion (>300%) that occurs during battery cycling, which upon repeated cycling causes fractures in and/or delamination of the electrode. In addition, a solid electrolyte interface (SEI) passivation layer is formed on the surface of the battery anode via electrolyte decomposition. The quality and stability of the SEI is important for the performance of the battery, and as such is also sensitive to the high volume expansion of the silicon in lithium-ion batteries. In turn, a SEI can form on fractured structures of the electrode, thereby depleting the available electrolyte and active lithium.

Various strategies are employed to attempt to minimize these disadvantages. One of these strategies is combining silicon with carbon materials, such as graphene or a carbon matrix and optionally encapsulating the silicon. For example, WO2012093224A1 discloses a silicon/carbon composite material consisting of an aggregate of silicon particles and carbon particles with improved electrochemical properties.

A different strategy is structuring the silicon in the form of nanostructures such as nanoparticles, nanowires, nanotubes or more complex 3D structures. Through these nanostructures the silicon is provided with ample space to accommodate volume expansion, reducing internal stress and fractures, while also maintaining a high surface area for lithium-ion transport from electrolyte to silicon. For example, WO2010129910A2 discloses a conductive substrate and silicon containing nanowires substrate-rooted to the conductive substrate. WO2015175509A1 expands upon this concept by having two layers of silicon material coating a nanowire template rooted to the substrate, wherein the second silicon layer has a higher density than the first layer. WO2015175509A1 states that hereby the first silicon layer provides space into which the silicon can expand as it absorbs lithium, while the second silicon layer reduces SEI layer formation.

U.S. Pat. No. 10,333,148B2 attempts to minimize the aforementioned disadvantages by disclosing an electrode having one or more electrode material layers with varying densities, wherein the layers are either gradient-formed or alternately stacked. The density of the formed layers is estimated by the mass loading of the active material, but specific porous structures are not identifiable.

US2013115510A1 attempts to minimize the aforementioned disadvantages by using a certain silicon active material with a certain surface configuration. It is disclosed that the surface configuration of the active material is important as opposed to the configuration of the surface of the current collector, and that a large surface area and a moderately rough surface configuration is preferable. Specifically, the anode surface should have a surface roughness Rz between 1.0 μm and 4.5 μm, while the copper current collector should have a surface roughness Rz between 2.0 μm and 5.0 μm.

WO 2021/029769 A1 discloses electrodeposition of a ZnO layer onto copper foil, followed by coating with amorphous Si.

WO 2018/071846 A1 discloses application of a slurry onto current collector materials.

Although improved silicon structures for anodes have been developed that attempt to mitigate the aforementioned disadvantages, there remains a need for further improved silicon structures that can be manufactured by simple and affordable methods.

### SUMMARY OF THE INVENTION

In view of the above discussion, aspects of the present disclosure provide an optimized composite electrode material for use in a battery, comprising a specific silicon active material structure having improved anode properties in a multilayer configuration, where the improved properties mainly relate to the prevention of pulverization or delamination of the silicon active material layers and/or depletion of available electrolyte.

The object of present invention is therefore to provide a composite electrode material comprising:
a current collector material layer having or exhibiting a surface roughness value selected from at least one of the following: an Sdr value of more than 40%; and an Sdq value of more than 1.0, as determined by white light interferometry according to ISO 25178 (2012);
an optional first silicon layer positioned on the current collector material layer, wherein the first silicon layer has a porosity of less than 30%, as determined by electron microscopy;
at least a second silicon layer positioned on either the optional first silicon layer or the current collector material layer, wherein the second silicon layer has a porosity ranging from a porosity higher than the porosity of the optional first layer, to a porosity of less than 80%, as determined by electron microscopy.

It is a further object to provide a method for producing the composite electrode material according to the invention, comprising the following steps:
a. providing a current collector material exhibiting a surface roughness value selected from at least one of the following: an Sdr value of more than 40% and an Sdq value of more than 1.0; each value being determined by white light interferometry according to standard method ISO 25178 (2012);
b. optionally, depositing silicon on the current collector material, comprising controlling the mixture, flow rate and/or pressure of an operating gas comprising a precursor gas comprising silicon to a first predetermined value to form a first silicon layer, wherein the first silicon layer has a porosity of less than 30%, as determined by electron microscopy;
c. depositing silicon on either the optional first silicon layer or the current collector material layer, comprising controlling the mixture, flow rate and/or pressure of the operating gas comprising a precursor gas comprising silicon to a second predetermined value to form at least a second silicon layer, wherein the second silicon layer has a porosity ranging from a porosity higher than the optional first silicon layer, to a porosity of less than 80%, as determined by electron microscopy.

It is yet a further object to provide a battery comprising an electrolyte, a cathode, a separator and the composite material according to the invention or the composite material obtainable according to the method according to the invention.

In a further aspect, the invention provides a use of the composite material according to the invention or the composite material obtainable according to the method according to the invention in a battery or for the manufacture of a battery.

### SHORT DESCRIPTION OF THE FIGURES

FIG. 1 shows schematic examples of composite electrode material according to the invention.

FIG. 2 shows a cross-sectional EM image of composite electrode material according to the invention.

FIG. 3 shows a cross-sectional EM image of composite electrode material according to the invention.

FIG. 4 shows top view EM images of composite electrode material according to the invention.

FIG. 5 shows top view EM images of various current collector material copper foil structures and subsequently deposited silicon layers according to the invention.

FIG. 6 shows the pore size or width and pore volume distribution of the electrode composite material according to the invention as determined by the Barrett-Joyner-Halenda (BJH) method pursuant to ISO 15901-2:2006.

FIG. 7 shows the capacity retention of a coin cell battery comprising the electrode material according to the invention over multiple charge-discharge cycles.

FIGS. 8A and 8B depict a graphical representation of the Sdq and Sdr values of Table 1.

FIG. 9 shows an illustration of the deposition of silicon according to the method of the invention resulting in the silicon layers according to the invention, comprising columnar structures.

### DETAILED DESCRIPTION OF THE INVENTION

A first aspect of the present disclosure relates to a composite electrode material comprising:
i) a current collector material layer exhibiting a surface roughness value selected from at least one of the following:
   an Sdr value of more than 40%; and
   an Sdq value of more than 1.0; each value being determined by white light interferometry according to standard method ISO 25178 (2012);
ii) optionally, a first silicon layer positioned on the current collector material layer, wherein the first silicon layer has a porosity of less than 30%, as determined by electron microscopy; and
iii) at least a second silicon layer positioned on either the optional first silicon layer or the current collector material layer, wherein the second silicon layer has a porosity ranging from a porosity higher than the porosity of the optional first layer, to a porosity of less than 80%, as determined by electron microscopy.

As disclosed in WO2021029769, applicants had previously developed a composite electrode material comprising silicon and copper or titanium foils and further comprising a metal or metal oxide adhesion layer in between the silicon layer and foil, which resulted in higher resistance against delamination and/or pulverization of silicon.

The present invention provides an improved composite electrode material. Preferably, the composite electrode material of the invention is an anode.

Applicants have found that a particular surface roughness or texture of the current collector material as a substrate for attachment of silicon active material leads to an improved performance of a composite electrode material comprising the current collector material and the silicon active material. In particular, the combination of surface roughness or texture of the current collector material and the particular structure of the silicon active material leads to an improved performance of the composite electrode material. For example, the composite electrode material according to the invention is more stable when the silicon active material layers have a specific porosity when positioned on top of a current collector material with a specific surface roughness value.

The current collector materials, such as copper foils, are typically first manufactured as smooth foils obtained either from a rolling mill or from electrodeposition. One or both sides of the foil may then roughened by a surface roughening process. Suitable surface roughening processes include etching methods (e.g. AC etching using chlorine ion-containing electrolytes) and plating methods (e.g. conventional copper electroplating using current density around the critical current density in copper sulfate-type electrolyte to electrodeposit fine copper particles). The latter method is especially effective, in order to obtain a copper foil surface with a well-defined surface configuration that can be used in the present invention. By controlling the copper concentration, composition, and temperature of the electrolyte, as well as the current density and duration of electrolysis, etc. By carrying these conditions a copper foil for current collector with the required surface roughness can be produced. Further methods in the art of roughening copper foils include utilizing a sulfate-copper-type aqueous solution. Two such methods are: (a) copper particulate growth plating (also referred to in the art as a “burned plating method” (typically performed at high electric current density around or over the critical current density); and (b) normal copper smooth plating (performed below critical current density to prevent detachment of the adhered copper particulates.

The surface roughness of the current collector material can be characterized in terms of indirect indices, which represent the “fineness” of features, which includes local gradients and the superficial area. Sdq is the mean value of local gradients present on the surface, while Sdr is a parameter indicating the rate of growth in the superficial area. If height parameters such as Sa and Sq are on a comparable level, the degree of fineness becomes finer as parameters Sdq (gradient) and Sdr (superficial area) become larger. In a very loose sense, the peaks of material on the surface are sharper and have a closer spacing.

The optional first silicon layer according to the invention is present on the current collector material layer and a surface area of one layer is in direct contact with a surface area of the other layer.

The optional first silicon layer according to the invention has a low porosity, thereby enabling an increased attachment of the silicon active material to the current collector material layer while also serving as a substrate for increased attachment of the second silicon layer. A high porosity of the optional first silicon layer reduces the increased attachment. Preferably, the optional first silicon layer according to the invention has a porosity of less than 30, 20 or 15%, more preferably of less than 10, 9, 8, 7 or 6%, most preferably of less than 5, 4, 3, 2 or 1%.

In the state of the art, the porosity of a silicon layer is commonly determined by the Barrett-Joyner-Halenda (BJH) method pursuant to ISO 15901-2:2006. ISO 15901-2:2006 describes a method for the evaluation of porosity and pore size distribution by gas adsorption, which is explained in more detail below. However, the silicon layers according to the invention may comprise multiple layers of different porosities. Production of the second silicon layer may require the optional first silicon layer as a substrate for its formation and specific structure. After production of the composite electrode material, multiple silicon layers cannot reliably be separated without damaging or fracturing the layers and thereby altering their porosity. Therefore, the BJH method (pursuant to ISO 15901-2:2006) is less suitable for determination of the exact porosity of each of the individual silicon layers of the composite electrode material when more than one silicon layer is present. Within the context of the present invention, porosity is measured by electron microscopy. However, the Barrett-Joyner-Halenda (BJH) method pursuant to ISO 15901-2:2006 is used for determining specific parameters of the invention, namely wherein the first, second and/or additional silicon layer(s) of the claimed invention comprise a plurality of aggregated particles, wherein the particles have pores:
determining the mean pore size or width; and
determining the pore size or width distribution mode.

Analysis of cross-sectional electron microscopy images of the produced composite electrode material is the method for determination of the porosity of the individual silicon layers of the composite material according to the invention. The analysis can be done by visual inspection of the images or automatically by using an image analysis algorithm that is configured to discern silicon material from void space in the silicon layers via for example a difference in pixel intensities using a suitable threshold. Thus, according to the invention, porosity of a silicon layer, preferably the optional first layer, the second or additional layer(s), more preferably the optional first layer or the additional layer(s), is preferably determined by electron microscopy.

The at least second silicon layer according to the invention is present or positioned on either the optional first silicon layer or the current collector material layer and a surface area of one layer is in direct contact with a surface area of the other layer.

The at least second silicon layer according to the invention has a higher porosity than the optional first layer. When the first layer is not present the second layer can have any porosity, but less than 80%. A high porosity enables more volume expansion of the silicon active material, which results in less stress and less risk of fractures during lithiation and delithiation cycles. In addition, lithium ion transport in the electrolyte phase is increased by a highly porous structure of the silicon layer. Preferably, the second silicon layer according to the invention has a porosity of more than 1, 2, 3, 4, 5, 6, 7, 8, 9 or 10%, more preferably of more than 5, 6, 7 or 8%. A sufficient amount of silicon active material needs to be present for energy storage. Thus, according to the invention the second silicon layer preferably has a porosity of from 5, 10 or 15 to 20, 25, 30, 35, 40, 45, 50, 55, 60, 70 or 80%, more preferably of from 6, 7, 8, 9 or 10 to 18, 20, 25 or 30%, most preferably of from 6 or 8 to 18%. The second silicon layer according to the invention preferably has a porosity ranging from a porosity higher than the porosity of the optional first silicon layer to a porosity of less than 80, 70, 60, 55, 50, 45, 40, 35 or 30%, more preferably of less than 30, 29, 28, 27, 26, 25, 24, 23, 22, 21, 20 or 19%, most preferably of less than 20 or 19%.

The porosity of the second silicon layer according to the invention can be determined by electron microscopy.

Average pore size of the material according to the invention are preferably determined according to the method specified by the ISO (International Organization for Standardization) standard: ISO 15901-2:2006 “Pore size distribution and porosity of solid materials by mercury porosimetry and gas adsorption—Part 2: Analysis of mesopores and macropores by gas adsorption” using nitrogen gas. Specific surface area of the material according to the invention is preferably determined according to the method specified by the ISO standard: ISO 9277:2010 “Determination of the specific surface area of solids by gas adsorption—BET method” using nitrogen gas. Briefly, for both ISO methods, a N₂ adsorption-isotherm is measured at about −196° C. (liquid nitrogen temperature). According to the calculation method of Barrett-Joyner-Halenda (Barrett, E. P.; Joyner, L. G.; Halenda, P. P. (1951), “The Determination of Pore Volume and Area Distributions in Porous Substances. I. Computations from Nitrogen Isotherms”, Journal of the American Chemical Society, 73 (1): 373-380) the pore size and pore volume can be determined. Specific surface area can be determined from the same isotherm according to the calculation method of Brunauer-Emmett-Teller (Brunauer, S.; Emmett, P. H.; Teller, E. (1938), “Adsorption of Gases in Multimolecular Layers”, Journal of the American Chemical Society, 60 (2): 309-319). Both calculation methods are well-known in the art. A brief experimental test method to determine the isotherm can be described as follows: a test sample is dried at a high temperature and under an inert atmosphere. The sample is then placed in the measuring apparatus. Next, the sample is brought under vacuum and cooled using liquid nitrogen. The sample is held at liquid nitrogen temperature during recording of the isotherm.

The term ‘void space’ or ‘void structure’ herein is understood to mean an area in a silicon layer that does not contain a component of the composite electrode. The void space or structure is empty or filled with atmospheric (liquid or gaseous) fluid. The void space or structure provides an area for the silicon to expand into during use of the composite electrode material. Moreover, electrolyte or electrolyte comprising lithium (ions) can be present in the void space or structure during use of the composite electrode material in a battery. Determination of the dimensions of the void space or structure is preferably performed by analysis of cross-sectional images of the layers or material by electron microscopy, wherein the cross section is perpendicular to the surface plane of the current collector material. A dimension of a void space or structure is preferably determined over a continuous area of the void space or structure by analysis of cross-sectional images of the layers or material.

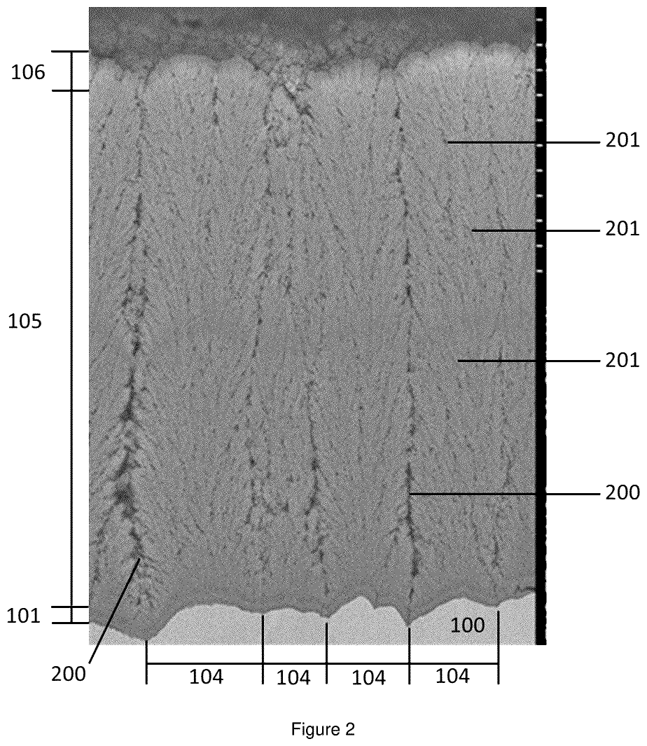

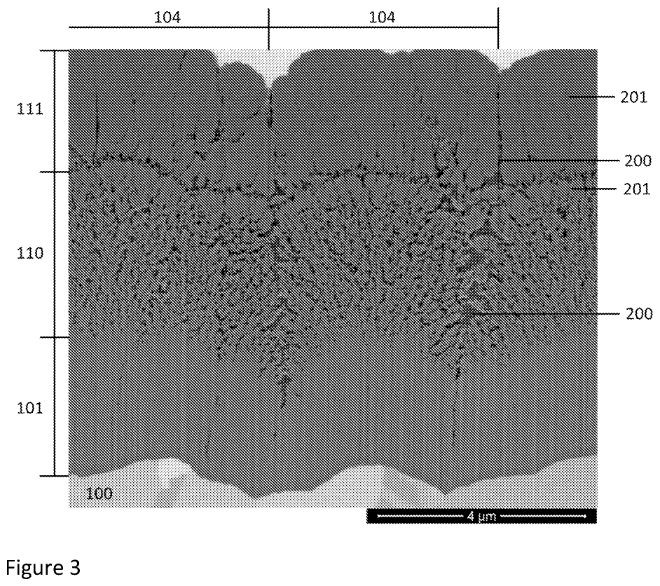

The at least second silicon layer according to the invention preferably comprises a plurality of void structures having a mean width of from 1 to 10 nm. The additional silicon layer according to the invention can comprise a plurality of void structures having a mean width of from 1 to 10 nm. The presence of void structures of the additional silicon layer depends on the porosity of the additional silicon layer. Preferably, the void structures comprise elongate tubular-like structures, channels, and/or a plurality of interlinked pores. The void structures mostly have an orientation with a substantially diagonal to perpendicular angle to the surface plane of the current collector material as can be determined from a cross-sectional electron microscope image perpendicular to the surface plane of the current collector material. Preferably, the void structures according to the invention have a mean width of from 1, 2, 3, 4 or 5 to 6, 7, 8, 9 or 10 nm. The void structures according to the invention can have a length of up to the thickness of the silicon layer. Their width can vary along their length. Typical void structures are exemplified in FIGS. 2 and 3.

Preferably, the composite material according to the invention comprises an additional silicon layer present on or positioned on top of the second silicon layer, and optionally one or more additional silicon layers each in turn present on or positioned on a respective directly underlying additional silicon layer, wherein each additional silicon layer has a porosity different from the porosity of the second silicon layer and/or the directly underlying additional silicon layer. According to the invention, porosity of a silicon layer, preferably the optional first layer, the second or additional layer(s), more preferably the optional first layer or the additional layer(s), is preferably determined by electron microscopy.

The at least second silicon layer according to the invention can be a gradient layer, wherein the gradient layer has a first surface and a second surface opposing the first surface, and a porosity that varies with a distance defined from the first surface to a plane parallel to the first surface in the second layer, wherein the maximal distance is a thickness of the gradient layer defined between the first and second surfaces. The additional silicon layer according to the invention can be a gradient layer, wherein the gradient layer has a first surface and a second surface opposing the first surface, and a porosity that varies with a distance defined from the first surface to a plane parallel to the first surface in the additional layer, wherein the maximal distance is a thickness of the gradient layer defined between the first and second surfaces. Preferably, either the first surface or the second surface is facing and in contact with the first silicon layer. Preferably, the porosity varies from a lowest porosity at one of the first and second surfaces to a highest porosity at the other of the first and second surfaces. Preferably, the porosity decreases from one of the first and second surfaces to a value at a point between the first surface and the second surface and increases from the value to the other of the first and second surfaces. Preferably, the porosity increases from one of the first and second surfaces to a value at a point between the first surface and the second surface and decreases from the value to the other of the first and second surfaces. Preferably, the point is a plane parallel to the first surface or the second surface. Preferably, the point is at a distance of from 5 to 95% of the maximal distance, wherein the maximal distance is a thickness of the gradient layer defined between the first and second surfaces. More preferably the point is at a distance of from 20 to 80% of the maximal distance, more preferably of from 30 or 40 to 60 or 70%. Preferably, the point is at a distance of about 10, 20, 30, 40 or 50% of the maximal distance.

A gradient layer according to the invention is understood to not have a clear demarcation in its layer with regard to porosity when assessed via for example electron microscopy. When a difference in porosity is referred to with regard to different, lower or higher porosities of different silicon layers according to the invention when compared to a silicon layer having a gradient layer, this is understood to be compared to the average porosity of the silicon layer having a gradient layer.

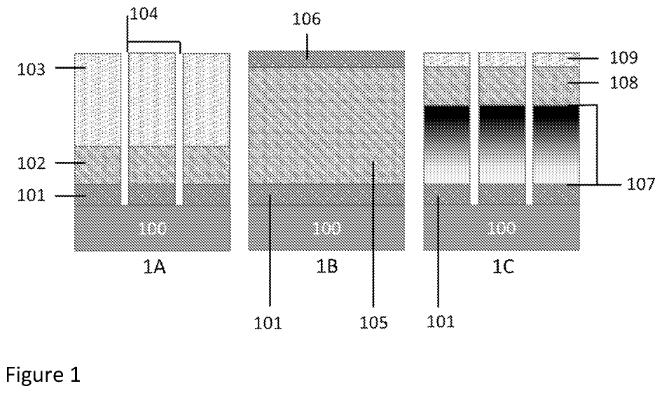

The multilayer configuration of the composite material according to the invention foresees in a stack of silicon layers each having a different porosity from a respective adjacent silicon layer. In such a configuration a first, preferably bottom, surface area of the second silicon layer is in direct contact with the surface area of the optional first silicon layer that is preferably opposite the surface area that is in direct contact with the current collector material layer, and a second, preferably opposite, surface area of the second silicon layer is in direct contact with the first, preferably bottom, surface area of the additional silicon layer. Alternatively, a first, preferably bottom, surface area of the second silicon layer is in direct contact with the surface area of the current collector, and a second, preferably opposite, surface area of the second silicon layer is in direct contact with the first, preferably bottom, surface area of the additional silicon layer. In addition, the first, preferably bottom, surface area of each of the optional one or more additional silicon layers is in direct contact with the second, preferably opposite, surface area of the respective directly underlying additional silicon layer. Examples of multilayer configurations are illustrated in FIG. 1. The composite material according to the invention preferably comprises multiple silicon layers formed such that layers having lower porosities and layers having higher porosities are alternately stacked to one another.

The composite material according to the invention preferably comprises, the silicon layer or layers, preferably the optional first layer, the second and/or the additional silicon layers, on only one side of the current collector material or on each of two sides of the current collector material.

Advantageously, the composite material according to the invention preferably comprises the silicon layers having a combined thickness of from 1 to 30 or 50 μm, preferably of from 5 or 10 to 15 or 20 μm or a mass loading of from 0.1 to 4 mg/cm², preferably of from 0.5, 0.8, 1.0, 2.0 to 2.5, 3.5 or 4.0 mg/cm². The combined thickness or the mass loading pertains to the silicon layers that are present on one side of a current collector material layer.

The low porosity of the optional first silicon layer has the disadvantage of providing less space for expansion of the layer during cycling, which increases stress in the layer and risk of fractures. Advantageously, the thickness of the optional first silicon layer is limited to reduce the risk of fractures, but sufficient to provide increased attachment to the current collector material and to serve as a suitable substrate for increased attachment of the second silicon layer. Preferably, according to the invention, the optional first silicon layer has a thickness of from 10 nm to 3 μm, more preferably of from 10 nm to 700 nm, even more preferably of from 50 nm to 500 nm, yet even more preferably of from 100 nm to 200 nm, the second silicon layer has a thickness of from 100 nm to 30 μm, preferably of from 3 to 25 μm, more preferably of from 5 to 20 μm, and an additional silicon layer has a thickness of from 100 nm to 30 μm, preferably of from 2 to 15 μm, more preferably of from 5 to 10 μm.

The composite material according to the invention preferably comprises the optional first layer, the second and/or additional silicon layers comprising an amorphous structure comprising proto-crystalline silicon regions, preferably wherein the amorphous structure comprised in the first silicon layer comprises nano-crystalline silicon regions in a higher fraction than the second silicon layer, preferably of up to about 80%, 70%, 60%, 50% or 40% by volume; or preferably wherein the amorphous structure comprised in the silicon layer comprises regions of nano-crystalline silicon in a fraction of up to about 30% by volume of the respective first, second and/or additional silicon layer.

The silicon layer according to the invention has preferably an amorphous structure in which nano-crystalline regions exist. More preferably, the silicon layer comprises up to 30% of nano-crystalline silicon. According to an embodiment, the silicon layer advantageously comprises n-type or p-type dopants to obtain a silicon layer of respectively n-type conductivity or p-type conductivity.

Advantageously, the silicon layer according to the invention comprises a silicon alloy or composite, wherein the silicon alloy is preferably selected from the group comprising Si—B, Si—C, Si—N, Si—Ge, Si—Ag and Si—Sn, more preferably selected from the group comprising Si—C and/or Si—N. Preferably, the composite material according to the invention comprises carbon or an alloy comprising carbon or silicon. The silicon alloy may be either an addition or an alternative to the amorphous silicon. Thus, according to an aspect of the invention, the material of the silicon layer comprises at least one material selected from amorphous silicon and amorphous silicon alloy.

A further aspect of the present disclosure relates to a composite electrode material according to any embodiment of the first aspect of the disclosure, which differs only in how the porosity is measured. In the first embodiment of this aspect, the porosity is measured by the Barrett-Joyner-Halenda (BJH) method pursuant to ISO 15901-2:2006. ISO 15901-2:2006 describes a method for the evaluation of porosity and pore size distribution by gas adsorption, which is explained in more detail below. However, the silicon layers according to the invention may comprise multiple layers of different porosities. Production of the second silicon layer may require the optional first silicon layer as a substrate for its formation and specific structure. After production of the composite electrode material, multiple silicon layers cannot reliably be separated without damaging or fracturing the layers and thereby altering their porosity. Therefore, the BJH method (pursuant to ISO 15901-2:2006) is less suitable for determination of the exact porosity of each of the individual silicon layers of the composite electrode material when more than one silicon layer is present.

Where the composite electrode material comprises a second silicon layer, the porosity of the second silicon layer according to the invention can be determined by the BJH method pursuant to ISO 15901-2:2006. The BJH method pursuant to ISO 15901-2:2006 has the advantage of being a faster and less cumbersome method of analysis than electron microcopy. The specific porosity percentages of the second layer or additional layer(s) according to the invention can be determined by the BJH method pursuant to ISO 15901-2:2006. Thus, porosity of the second or an additional silicon layer according to the invention can be determined by the BJH method pursuant to ISO 15901-2:2006, which is explained in more detail below.

Porosity and (average) pore size of the material according to the invention are preferably determined according to the method specified by the ISO (International Organization for Standardization) standard: ISO 15901-2:2006 “Pore size distribution and porosity of solid materials by mercury porosimetry and gas adsorption—Part 2: Analysis of mesopores and macropores by gas adsorption” using nitrogen gas. Specific surface area of the material according to the invention is preferably determined according to the method specified by the ISO standard: ISO 9277:2010 “Determination of the specific surface area of solids by gas adsorption-BET method” using nitrogen gas. Briefly, for both ISO methods, a N₂ adsorption-isotherm is measured at about −196° C. (liquid nitrogen temperature). According to the calculation method of Barrett-Joyner-Halenda (Barrett, E. P.; Joyner, L. G.; Halenda, P. P. (1951), “The Determination of Pore Volume and Area Distributions in Porous Substances. I. Computations from Nitrogen Isotherms”, Journal of the American Chemical Society, 73 (1): 373-380) the pore size and pore volume can be determined. Specific surface area can be determined from the same isotherm according to the calculation method of Brunauer-Emmett-Teller (Brunauer, S.; Emmett, P. H.; Teller, E. (1938), “Adsorption of Gases in Multimolecular Layers”, Journal of the American Chemical Society, 60 (2): 309-319). Both calculation methods are well-known in the art. A brief experimental test method to determine the isotherm can be described as follows: a test sample is dried at a high temperature and under an inert atmosphere. The sample is then placed in the measuring apparatus. Next, the sample is brought under vacuum and cooled using liquid nitrogen. The sample is held at liquid nitrogen temperature during recording of the isotherm.

A further aspect of the present disclosure relates to a composite electrode material according to any embodiment of the first aspect of the disclosure, which differs only in how the porosity is measured. In the first embodiment of this aspect, analysis of cross-sectional electron microscopy images of the composite electrode material according to the invention can advantageously be combined with the BJH method pursuant to ISO 15901-2:2006 for determining the porosity of multiple silicon layers, e.g. a first silicon layer and a second silicon layer according to the invention. Data of the results of the BJH method can be combined with an image analysis algorithm. For example, the BJH method is first used to measure the porosity of a composite electrode according to the invention comprising multiple silicon layers. Next, the algorithm can determine the porosity of a silicon layer by analyzing cross-sectional electron microscopy images of the composite electrode according to the invention comprising multiple silicon layers, after which the determined porosity is compared to historical data of the BJH method that were used to determine specific porosities of a single silicon layer. Then the algorithm can use the historical BJH data of a single layer to determine the porosity of the multiple silicon layers while also using the most recent BJH data.

According to a further aspect, the material of the silicon layer comprises amorphous silicon and nano-crystalline silicon alloy. In some embodiments, the silicon alloy may be present in the silicon layer as a nano-crystalline phase. Also, the silicon layer may comprise a mixture of an amorphous material and nano-crystalline phase. For example, a mixture of amorphous silicon and nanocrystalline silicon, or a mixture of amorphous silicon with nano-crystalline silicon alloy, or a mixture of silicon and silicon-based alloy predominantly in an amorphous state comprising a fraction (up to about 30%) of the mixture in a nano-crystalline state.

The term “amorphous silicon” herein is understood to mean as comprising proto-crystalline silicon, which is a definition for amorphous silicon comprising a fraction of nano-crystalline silicon. This fraction may be up to about 30% of the silicon layer. For ease of reference the term amorphous silicon will be used herein to indicate that the silicon layer comprises amorphous silicon, in which nano-crystalline regions of the silicon layer may be present with a fraction of nanocrystalline silicon up to about 30%.

The silicon layer according to the invention may comprise silicon oxide.

Crystalline silicon and amorphous silicon can be determined by Raman spectroscopy. For crystalline silicon, the first-order Raman spectra displays a sharp peak at the Raman shift of 520 cm⁻¹. For amorphous silicon, a broad optical band peak at 470 cm⁻¹ is displayed in the first order Raman spectra. The ratio between the area under the two respective peaks can be used to determine the fraction of crystalline silicon (by volume).

The silicon layers according to the invention are preferably organized on the current collector in a plurality of columnar structures separated by major void structures. The columnar structures are arranged adjacent to each other. This configuration facilitates volume expansion during cycling and electrolyte and ion transport.

The silicon layer, preferably the optional first layer, the second and/or additional layer(s), more preferably the second and/or additional layer(s), according to the invention preferably comprises a plurality of columnar structures, the columnar structures extending in a substantially perpendicular direction from the surface plane of the current collector material. The surface plane of the current collector material herein is understood to mean the interface between the current collector material layer and the first silicon layer. For the purpose of determining relative orientation or direction, the surface plane is considered to be flat (i.e. have two dimensions) and to not be influenced by irregularities present in the current collector material layer or the interface between the current collector material layer and the first silicon layer. For clarity, as is evident from this disclosure, irregularities present in the current collector material do influence the properties of the electrode composite material according to the invention.

The silicon layer, preferably the optional first layer, the second and/or additional layer(s), more preferably the second and/or additional layer(s), according to the invention preferably comprise a plurality of major void structures having a mean width of from 10 nm to 150 nm, preferably determined by analysis of electron microscopy images of cross sectional sections of the composite electrode material. Preferably, the major void structures have an orientation with a substantially perpendicular angle to the surface plane of the current collector material. Preferably, the orientation can be determined from a cross-sectional electron microscope image perpendicular to the surface plane of the current collector material. Preferably, the major void structures comprise elongate tubular-like structures, channels, and/or a plurality of interlinked pores. Preferably, the major void structures according to the invention have a mean width of from 10, 20, 30, 40 or 50 to 100, 110, 120, 130, 140 or 150 nm. The major void structures according to the invention can have a width of up to several hundred nm or even 1 μm. Their width usually varies along their length. The major void structures according to the invention can have a length of up to the thickness of the silicon layer. Typical major void structures are exemplified in FIGS. 2 and 3.

The silicon layer, preferably the optional first layer, the second and/or additional layer(s), more preferably the second and/or additional layer(s), according to the invention preferably comprise a plurality of columnar structures, the columnar structures extending in a substantially perpendicular direction from the surface plane of the current collector material, wherein major void structures are present between the columnar structures, preferably wherein the major void structures extend in a substantially perpendicular direction from the surface plane of the current collector material. Preferably, the major void structures surround each of the plurality of columnar structures. Preferably, a major void structure extends from the bottom to the top of a respective silicon layer and surrounds, preferably continuously surrounds, a columnar structure, thereby defining an individual columnar structure.

According to the invention, the plurality of columnar structures preferably comprises the columnar structures each having a mean diameter of from 0.5 to 10 μm, preferably of from 1, 2 or 3 to 5, 6, 7, 8 or 9 μm. According to the invention, the plurality of columnar structures preferably comprises the plurality of columnar structures having a mean diameter of from 0.5 to 10 μm, preferably of from 1, 2 or 3 to 5, 6, 7, 8 or 9 μm.

The structure of the current collector material can have an influence on the major void structures and the structure of the columnar structures of the silicon layer according to the invention. The current collector material according to the invention preferably comprises a sheet-like material or a foil, preferably produced by cold rolling or electroplating. Preferably, the current collector material comprises copper, tin, chromium, nickel, titanium, iron or silver, or an alloy thereof, including stainless steel. More preferably, the current collector material comprises copper or titanium, most preferably the current collector material comprises copper or the current collector material consists (substantially) of copper. Preferably, the current collector material comprises alloys of copper or titanium with elements such as magnesium, zinc, tin, phosphor and/or silver. Preferably, the current collector material is rough or textured. Preferably, the current collector material has a tensile strength preferably ranging from 150 to 600 MPa. Preferably, the current collector material can comprise a passivation layer deposited on the copper foil to protect the copper foil from oxidation in air. The sheet-like materials produced by cold rolling or electroplating can have certain defects such as rolling lines, potential strains, impurities, and native oxide, which can impact the quality of the active material layer. Thus, the current collector material according to the invention may be subjected to surface treatment. For example, the roughness of the current collector material can be increased, or the surface texture can be altered, to varying degrees by attaching nodules of current collector material or other metals to the surface of the current collector material, for example by electroplating. Other examples of surface treatment techniques known in the art include annealing, knurling, etching, liquefying, physical polishing and electro-polishing, and are used to improve the morphology of the current collector material prior to deposition of active material. The texture of the surface may also be altered by imprinting or stamping a specific preferred pattern in the current collector material.

Preferably, the current collector material according to the invention comprises rough or textured current collector material, preferably roughened or nodule-treated current collector material.

Preferably, the current collector material according to the invention exhibits or has a surface roughness value or texture with an Sa or Ra, preferably Sa, value of more than 0.35, 0.4 or 0.5 μm, preferably of from 0.35, 0.4, 0.45 or 0.5 to 0.85, 0.9, 1.0, 1.5, 2.0, 3, 5 or 10 μm. More preferably, the Sa or Ra, preferably Sa, value is more than 0.5 μm or of from 0.5 to 2 μm. Preferably, the current collector material according to the invention exhibits or has a surface roughness value or texture with an Sq or Rq, preferably Sq, value of more than 0.43, 0.45, 0.5 or 0.6 μm, preferably of from 0.43, 0.45, 0.5 or 0.6 to 0.85, 0.9, 1.0, 1.5, 2.0, 3, 5 or 10 μm. More preferably, the Sq or Rq, preferably Sq, value is more than 0.6 μm or of from 0.6 to 2.5 μm. Preferably, the current collector material according to the invention exhibits or has a surface roughness value or texture with an Sz or Rz, preferably Sz, value of more than 4, 4.7, 5.0, 5.5 or 6 μm, preferably of from 4.5, 4.7, 5.0, 5.1, 5.5, 6 to 9, 10, 11, 12, 14 or 15 μm. More preferably, the Sz or Rz, preferably Sz, value is more than 5.0 μm or of from 5.5 to 14 μm. Preferably, the current collector material according to the invention exhibits or has a surface roughness value or texture with an Sdr value of more than 40, 50, 60, 75, 90, 91 or 95%, preferably of from 40, 50, 75, 90, 91 or 95 to 400 or 500%. More preferably, the Sdr value is more than 50% or of from 50 to 500%. Preferably, the current collector material according to the invention exhibits or has a surface roughness value or texture with an Sdq value of more than 1.0, 1.05, 1.1, 1.2, 1.51, 1.55 or 1.6, preferably of from 1.05, 1.1, 1.2, 1.51, 1.55 or 1.6 to 4 or 5. More preferably, the Sdq value is more than 1.0, 1.05, 1.51 or 1.6 or of from 1.05, 1.51 or 1.6 to 5. Preferably, the current collector material according to the invention exhibits or has a surface roughness value or texture with an Ssc of more than 8 or 8.5 (1/μm), preferably of from 8 or 8.5 to 20, 30, 40 or 50 (1/μm). More preferably, the Ssc value is more than 8 (1/μm) or of from 8 to 50 (1/μm). Preferably, the current collector material according to the invention exhibits or has a surface roughness value or texture with an Sds value of more than 0.41, 0.42, or 0.43, preferably of from 0.41, 0.42, or 0.43 (1/μm²) to 1.0, 1.25 or 1.5 (1/μm²). More preferably the Sds value is more than 0.41 (1/μm²) or of from 0.41 to 1.5 (1/μm²).

The current collector material according to the invention may exhibit or have the preferred values of one or any combination of the individual surface roughness value or texture parameters as indicated above.

Preferably, the current collector material according to the invention exhibits a surface roughness or texture value selected from at least one of the following:
an Sz value of more than 5.0 μm;
an Sds value of more than 0.41; and
an Ssc value of more than 8.0; each value being determined by white light interferometry according to standard method ISO 25178 (2012).

Therefore, the current collector material according to the invention preferably exhibits a surface roughness value selected from at least one of the following: an Sdr value of more than 40%; and an Sdq value of more than 1.0, and additionally exhibits a surface roughness value selected from at least one of the following: an Sz value of more than 5.0 μm; an Sds value of more than 0.41; and an Ssc value of more than 8.0, wherein each value is determined by white light interferometry according to standard method ISO 25178 (2012). In Table 1 various collector materials are exemplified that exhibit these preferred surface roughness values. Where in this specification reference is made to the ISO 25178 method, this is understood as to refer to the 2012 version thereof.

Preferably, the current collector material according to the invention exhibits a surface roughness value Sdr of more than 40% and an Sdq value of more than 1.0. Preferably, the current collector material according to the invention exhibits a surface roughness value Sdr of more than 40% and an Sz value of more than 5.0 μm. Preferably, the current collector material according to the invention exhibits a surface roughness value Sdr of more than 40% and an Sds value of more than 0.41. Preferably, the current collector material according to the invention exhibits a surface roughness value Sdr of more than 40% and an Ssc value of more than 8.0. Preferably, the current collector material according to the invention exhibits a surface roughness value Sdq of more than 1.0 and an Sz value of more than 5.0 μm. Preferably, the current collector material according to the invention exhibits a surface roughness value Sdq of more than 1.0 and an Ssc value of more than 8.0. Preferably, the current collector material according to the invention exhibits a surface roughness value Sdq of more than 1.0 and an Sds value of more than 0.41. Preferably, the current collector material according to the invention exhibits a surface roughness value Sdr of more than 40%, an Sdq value of more than 1.0, and an Sz value of more than 5.0 μm. Preferably, the current collector material according to the invention exhibits a surface roughness value Sdr of more than 40%, an Sdq value of more than 1.0, and an Sds value of more than 0.41. Preferably, the current collector material according to the invention exhibits a surface roughness value Sdr of more than 40%, an Sdq value of more than 1.0, and an Ssc value of more than 8.0. Preferably, the current collector material according to the invention exhibits a surface roughness value Sdr of more than 40%, an Sdq value of more than 1.0, an Sz value of more than 5.0 μm, and an Sds value of more than 0.41. Preferably, the current collector material according to the invention exhibits a surface roughness value Sdr of more than 40%, an Sdq value of more than 1.0, an Sz value of more than 5.0 μm, and an Ssc value of more than 8.0. Preferably, the current collector material exhibits a surface roughness value selected from (i) an Sz value of 5.0 to 11.0 μm; an Sds value of 0.41 to 0.80 per μm²; and an Ssc value of 8.0 to 17.0 per μm. More preferably, the current collector material exhibits a surface roughness value selected from (i) an Sz value of 6.0 to 10.0 μm; an Sds value of 0.50 to 0.75 per μm²; and an Ssc value of 10.0 to 15.0 per μm. Even more preferably, the current collector material exhibits a surface roughness value selected from (i) an Sz value of 7.0 to 9.0 μm; an Sds value of 0.60 to 0.70 per μm²; and an Ssc value of 12.0 to 14.0 per μm.

The parameters Sa, Ra, Sq, Rq, Sz, Rz, Sdr, Sdq, Ssc and Sds are determined by white light interferometry and calculated pursuant to the standard test method ISO 25178-3:2012, relating to the analysis of 3D areal surface texture and roughness.

The following descriptions of the parameters are general descriptions. It should be understood that the descriptions and definitions as disclosed in the aforementioned standard test method should be used when determining exact values.

Ra is the average height of a line. Sa is the extension of Ra to a surface. It expresses the difference in height of each point compared to the arithmetical mean of the surface. Rq is the root mean square deviation of a line. Sq is the extension of Rq to a surface. Sq represents the root mean square value of ordinate values within the definition area. It is equivalent to the standard deviation of heights. Rz is the average maximum profile height of a line. Sz is the extension of Rz to a surface. Sz is the sum of the largest peak height value and the largest pit depth value within the defined area. As Sa, Sq or Sz provide a more consistent determination of a surface area than respectively Ra, Rq or Rz, the current collector material according to the invention preferably has a surface roughness or texture with a Sa, Sq or Sz of the values as indicated above.

However, Sa and Sq are less well-suited in differentiating peaks, valleys and the spacing of the various texture features of a surface area. Therefore, surfaces with differences in spatial and height symmetry features may have the same Sa or Sq, but may function differently. Thus, the current collector material according to the invention preferably has a surface roughness or texture with a Sz, Sdq, Sdr, Sds or Ssc of the values as indicated above.

Ssc, Sds, Sdq and Sdr are known as hybrid or feature parameters, which treat a surface as a series of features instead of a single surface of generalized roughness. It was found that these parameters better define the ideal current collector material according to the invention, in particular Sdq and Sdr. Thus, the current collector material according to the invention more preferably has a surface roughness or texture with a Sdq, Sdr, Sds or Ssc of the values as indicated above, most preferably with a Sdq or Sdr of the values as indicated above.

Sds (summit density) counts the number of summits (derived from peaks) per area of the surface. Sds values also influence columnar structure size and density. A higher Sds value translates to smaller columnar structures at a higher density per unit area.

Ssc (mean summit curvature) relates to the shape and size of the higher areas of a surface.

Sdq (root mean square gradient) is calculated as a root mean square of slopes at all points in the definition surface area. The Sdq of a completely level surface is 0. Sdq is a general measurement of the slopes which comprise the surface and may be used to differentiate surfaces with similar average roughness Sa.

Sdr (developed interfacial area ratio) is expressed as the percentage of the definition area's additional surface area contributed by the texture as compared to an ideal plane the size of the measurement region. The Sdr of a completely level surface is 0. Sdr can be used to further differentiate surfaces of similar amplitudes and average roughness.

Preferably, the composite material according to the invention comprises major void structures, wherein the major void structures originate from irregularities present on the surface of the current collector material layer, preferably the surface facing the first silicon layer. Preferably, the composite material according to the invention comprises columnar structures, wherein the columnar structures originate from irregularities present on the surface of the current collector material layer, preferably the surface facing the first silicon layer.

In the pending international patent application WO2021029769 of current applicant, applicant has found that an adhesion layer comprising a metal, metal alloy and/or metal salts and/or oxide attached to the current collector material, increases adhesion of the silicon material to the current collector material of the composite electrode.

Preferably, the current collector material according to the invention comprises a metal, metal alloy and/or metal salts and/or oxide.

According to the present invention, the current collector material comprising a metal, metal alloy and/or metal salts and/or oxide adhesion layer preferably comprises an adhesion layer. This adhesion layer increases the adhesion between silicon material and the current collector material as different complexes of silicon are being formed on the interface between the current collector material and the silicon. Such an adhesion layer preferably comprises chromium, nickel, zinc or tin, more preferably ZnO or SnO₂. The adhesion layer can be formed by coating or depositing the metal, metal alloy and/or metal salts and/or oxide on the current collector material. Preferably, the adhesion layer has a thickness of from 0.1 to 5 nm, more preferably of from 1 to 2 nm.

The metal, metal alloy and/or metal salts and/or oxide according to the invention are advantageously selected from aluminium, copper, nickel, tin, chromium, indium and zinc, preferably nickel, ZnO or SnO₂, most preferably ZnO; preferably, wherein the current collector comprises a copper or nickel core layer, more preferably a core layer doped with oxides or fluorides of chromium, zinc, aluminium, tin or indium. Preferably, the metal, metal alloy and/or metal salts and/or oxide or the core layer are in a layer at a thickness of from 0.1 to 5 nm, more preferably of from 1 to 2 nm. Preferably, a current collector according to the invention comprising copper or nickel comprises nickel, ZnO or SnO₂.

The term “doping” is herein understood to mean introducing a trace of an element into a material to alter the original electrical properties of the material or to improve the crystal structure of the silicon material.

The silicon layer, preferably the optional first layer, the second and/or additional silicon layer(s), according to the invention, preferably comprises a plurality of particles, preferably aggregated particles. Preferably, the particles have pores. Preferably, the pores have a mean pore size or width of from 2.5 to 5 nm as determined pursuant to the method according to ISO 15901-2:2006. The method according to ISO 15901-2:2006 is explained in more detail above. Preferably, the pores have a mean pore size or width of from 3 to 4.5 or 5 nm, more preferably of from 3.5 to 4 nm. Preferably, the pores have a size or width distribution mode of from 1 to 5 nm, as determined by the Barrett-Joyner-Halenda (BJH) method pursuant to ISO 15901-2:2006. Preferably, the pores have a size or width distribution mode of from 2 to 4 nm. The method according to ISO 15901-2:2006 is explained in more detail above. The specific pore size or width according to the invention is optimized in order to have a fast lithium-ion transport, but also to minimize SEI layer formation while maintaining the function of enabling volume expansion of the silicon during cycling. The particles according to the invention preferably have a substantially spherical or spheroid shape.

Advantageously, the silicon layer according to the invention, preferably the second and/or additional layer(s), has a specific surface area of up to 105 m²/g as measured by the Brunauer-Emmett-Teller (BET) method pursuant to ISO 9277:2010, preferably of from 10 to 105 m²/g, more preferably of from 25, 30, 40 or 50 to 85, 90, 95 or 100 m²/g, most preferably of from 30 to 90 m²/g. The Brunauer-Emmett-Teller (BET) method pursuant to ISO 9277: 2010 is explained in more detail above. The specific surface area of the silicon layer according to the invention is optimized to strike a balance between improved lithium transfer from electrolyte to silicon and vice versa and reduced electrolyte reactions with the silicon, which leads to depletion of functional electrolyte from the battery. A high specific surface area has increased lithium transfer, but also increased electrolyte side reactions with silicon.

In a particularly preferable embodiment of the first aspect, the composite material according to any previous embodiment is one wherein the first silicon layer and/or second silicon layer comprises a plurality of adjacent columns extending in a perpendicular direction from the current collector layer. Where the first and/or second silicon layer comprise a plurality of adjacent columns, the columns extending in a perpendicular direction from the anode surface. The plurality of columns are arranged is a random but “continuous” fashion, i.e., adjacent to each other while separated by interfaces extending in the perpendicular direction. The plurality of columns comprise silicon and preferably have an amorphous structure. One advantage of such a morphology is that the composite material, for instance when used in a rechargeable battery, is that lithium ion (de) intercalation in or out of the first and/or second silicon layer is facilitated by the plurality of columns and the interfaces between them. The plurality of columns and interfaces provide improved lithium-ion accessibility in and out of the structure of the columns that comprise silicon in the layer during lithium-ion insertion and extraction. This allows for improved storage capacity per unit weight of the anode layer and reduced capacity fading over multiple recharging cycles.

More preferably, the composite material is one in which the adjacent columns being separated by column boundaries extending in the perpendicular direction with respect to the current collector layer.

Preferably, the composite material is one wherein the first silicon layer and/or the second silicon layer comprises n-type or p-type dopants. This advantageously allow the first silicon layer and/or the second silicon layer to exhibit either n-type conductivity or p-type conductivity, respectively.

Preferably, the composite material is one wherein the column boundaries resemble grain-like column boundaries. According to the present disclosure, “grain-like column boundaries” refers to a type of interface or region between adjoining silicon columns that resemble grain or crystal boundaries as customarily defined for grains consisting of crystalline atomic lattices. So, although the plurality of silicon columns comprises potentially entirely amorphous silicon-based material, the silicon columns may exhibit a grain-like engagement between adjoining columns.

Preferably, the composite material is one wherein the column boundaries form diffusion paths for lithium ions during intercalation and deintercalation. This advantageously allows for: (i) improved lithium diffusion through the first and/or second silicon layer, hence increased storage capacity; and (ii) improved resistance to volumetric changes and stress increase/decrease of the silicon layer(s) during the (de) intercalation process.

Preferably, the composite material is one wherein the silicon columns comprise dendritic or multibranch silicon columns.

Preferably, the composite material is one wherein the spatial distribution or arrangement of the plurality of silicon columns is a substantially random distribution across the current collector layer.

Preferably, the composite material is one wherein the adjacent columns further comprise a silicon alloy.

Preferably, the composite material is one wherein the silicon alloy has an amorphous structure. Even more preferably, the composite material is one wherein the silicon alloy is selected from a group of alloys comprising Si—B, Si—C, Si—N, Si—P, Si—Ge, Si—Ag, and Si—Sn.

Preferably, the composite material is one wherein the adjacent columns are elongated in the perpendicular direction. Such a morphology allows for greater freedom to the columns to expand or contract laterally with respect to the direction perpendicular to the current collector layer, thereby minimizing cracking, delamination and pulverization of the first and/or second silicon layers.

Preferably, the composite material is one wherein the adjacent columns have a length in the perpendicular direction of about 0.1 μm to about 10 μm.

Preferably, the composite material is one wherein the adjacent columns have an average footprint of 0.25 to 0.5 μm², along the surface of the current collector layer. This affords an improved aspect ratio between a base width and length/height in the perpendicular direction of each of the columns. This further minimizes cracking and or pulverization of the first and/or second silicon layers on the volumetric changes that occur during lithium (de) intercalation.

A further aspect of the invention is a battery, comprising an electrolyte, a cathode, a separator and the composite material according to the invention or the composite material obtainable according to the method of the invention, preferably comprising a lithium salt. A unit that incorporates at least an electrolyte, a cathode, a separator and the composite material according to the invention can be considered a battery cell.

The battery according to the invention preferably comprises an electrolyte comprising a medium and a lithium salt compound arranged between the cathode and the assembly.

The medium may be liquid or solid. An electrolyte comprising a liquid medium and a lithium salt may for example comprise any of LiPF₆, LiBF₄, LiTFSI, LIFSI or LiClO₄ in an organic solvent comprising or consisting of ethylene carbonate, dimethyl carbonate, propylene carbonate, ethyl methyl carbonate, or diethyl carbonate, or mixtures of any combination thereof, or other lithium salts and solvents known in the art such as room-temperature ionic liquids. The electrolyte may be solid such as a ceramic electrolyte, a polymer or a gel. The lithium salt in a solid ceramic electrolyte is usually present as a lithium metal oxide. Examples of solid ceramic electrolytes are lithium super ion conductors, agyrodites, sulfide solid electrolytes and perovskites optionally arranged as an amorphous structure. The medium may comprise other additives.

The battery according to the invention preferably comprises a single composite material or a multitude of composite materials. The single or multitude of composite materials according to the invention may be folded or rolled to obtain a suitable configuration for use in a battery.

Advantageously, the battery according to the invention preferably has the electrolyte, cathode, separator and composite material in a rolled or folded configuration or contained within a non-metallic pouch.

Examples of battery cells are cylindrical, prismatic, pouch and coin cells. Several configurations of cells can also be combined. For example, a coin cell can have an internal cylindrical configuration (as disclosed in international patent application WO2015188959A1) or a pouch cell can have an internal prismatic configuration.

Preferably, the battery according to the invention comprises a single anode electrode tab. Preferably, such a battery comprises a prismatic cell or a cylindrical cell.

Another aspect of the invention is the use of the composite material according to the invention or the composite material obtainable according to the method of the invention in a battery or for the manufacture of a battery.

An additional aspect of the invention is the use of the composite material or the battery according to the invention as an energy storage and/or release device or for the manufacture of an energy storage and/or release device.

The term “energy storage and/or release device” herein is understood to mean a secondary battery, including an electrode assembly of a cathode/separator/anode structure mounted in a suitable battery case. Such batteries include lithium-ion secondary batteries, which excel in providing high energy density, and a high capacity; and their use in secondary battery modules comprising a plurality of secondary batteries, which are typically connected in series with each other to form a battery pack that can be incorporated into a casing to form the module.

A further aspect of the invention is a method for producing a composite electrode material, comprising the following steps:
a. providing a current collector material exhibiting a surface roughness value selected from at least one of the following: an Sdr value of more than 40% and an Sdq value of more than 1.0; each value being determined by white light interferometry according to standard method ISO 25178 (2012);
b. optionally, depositing silicon on the current collector material, comprising controlling the mixture, flow rate and/or pressure of an operating gas comprising a precursor gas comprising silicon to a first predetermined value to form a first silicon layer, wherein the first silicon layer has a porosity of less than 30%, as determined by electron microscopy;
c. depositing silicon on either the optional first silicon layer or the current collector material layer, comprising controlling the mixture, flow rate and/or pressure of the operating gas comprising a precursor gas comprising silicon to a second predetermined value to form at least a second silicon layer, wherein the second silicon layer has a porosity ranging from a porosity higher than the optional first silicon layer, to a porosity of less than 80%, as determined by electron microscopy.

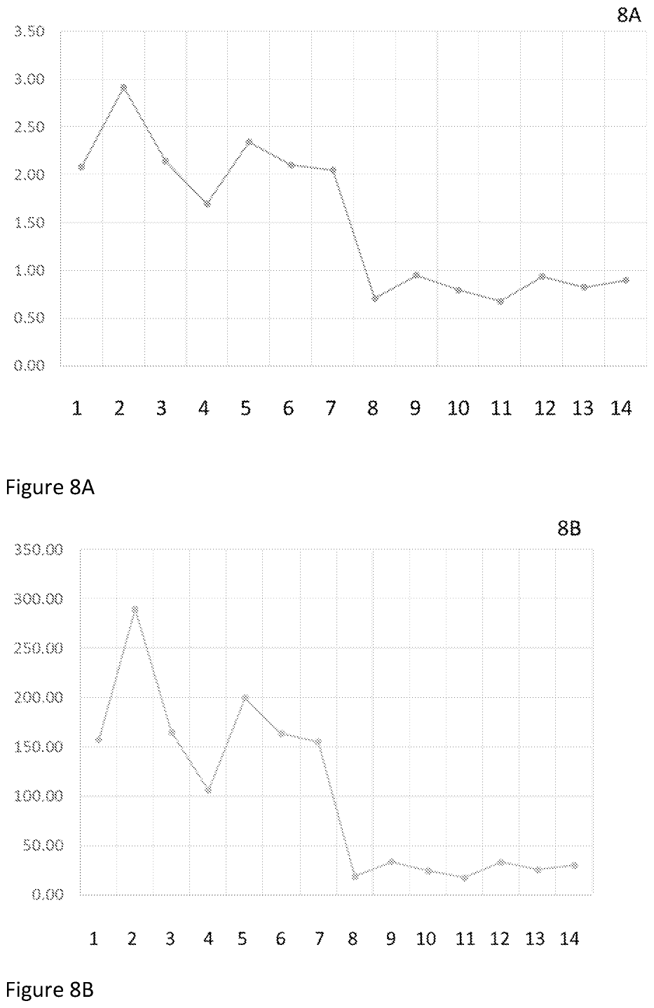

The deposition of silicon according to the method of the invention resulting in the silicon layers according to the invention is illustrated in FIG. 8. Small clusters of amorphous silicon are formed by gas phase reaction. The silicon is deposited with a process called ballistic growth, in which particles move towards the substrate and adhere to it.

Preferably, the method according to the invention is a method for producing a composite electrode material according to the invention.

By controlling various parameters such as mixture (mixing ratio), flow rate and/or pressure of an operating gas comprising a precursor gas comprising silicon to different predetermined values different silicon layers with different structures and properties can be obtained when depositing the silicon on the current collector material. The terms ‘mixture’ and ‘mixing ratio’ are used interchangeably herein.

Preferably, according to the method of the invention, depositing silicon comprises depositing silicon to form the at least second silicon layer such that the second silicon layer comprises a plurality of void structures having a mean width of from 1 to 10 nm. Preferably, according to the method of the invention, depositing silicon comprises depositing silicon to form the optional first layer, the second and/or additional layer(s) such that the optional first layer, the second and/or additional layer(s) comprise a plurality of major void structures having a mean width of form 10 nm to 150 nm, preferably having an orientation with a substantially perpendicular angle to the surface plane of the current collector material.

During the formation process, silicon columnar structures extend perpendicularly to a surface of the current collector material. The plurality of silicon columnar structures is arranged adjacent to each other while interspersed by major void structures extending in a substantially perpendicular direction, with the width of the major void structures being substantially parallel to the surface of the composite electrode material. Once formed, the silicon layer comprises amorphous silicon, as verified by Raman spectroscopy as detailed above. An advantage of the method according to the invention is that the plurality of silicon columnar structures is formed in an organizing fashion and randomly distributed across the current collector material, so it is not necessary to actively steer or control the formation of each individual silicon layer, unless for example the formation of a porosity gradient is required. The method of the present invention is therefore a self-organizing, spontaneous process for forming a composite electrode material without post-processing steps. As a result, the method is readily adapted to produce silicon-based anodes at industrial levels for commercialization.

The method according to the invention preferably comprises a step d. of depositing silicon on the at least second silicon layer, comprising controlling the mixture, flow rate and/or pressure of the operating gas comprising silicon to a predetermined value to form an additional silicon layer, wherein the additional silicon layer has a porosity different from the porosity of the second silicon layer, and optionally comprising a step e. of depositing silicon on the additional silicon layer, comprising controlling the mixture, flow rate and/or pressure of the operating gas comprising silicon to a predetermined value to form an additional silicon layer, wherein the additional silicon layer has a porosity different from the porosity of the directly underlying additional silicon layer, wherein step e. is optionally repeated. The porosity of the different layers is preferably determined by electron microscopy.

Depositing silicon according to the method of the invention preferably comprises controlling the mixture, flow rate and/or pressure of the operating gas comprising silicon and/or controlling the power input and/or frequency to form the silicon layer having a specific surface area, porosity and/or thickness. When a gradient layer according to the invention is to be formed, depositing silicon according to the invention comprises gradually controlling to form the silicon layer having a porosity that varies with the distance.

Depositing silicon according to the method of the invention preferably comprises depositing silicon on only one side of the current collector material or on each of two sides of the current collector material. Various configurations using various predetermined values can be foreseen yielding symmetric or asymmetric stacks of silicon layers, in number or properties such as for example porosity, void structures or columnar structures, when considered from the current collector material layer.

Advantageously, according to the method of the invention, the method preferably comprises, prior to providing the current collector material, a step of adding irregularities to the current collector material, preferably increasing the roughness of the current collector material or altering the texture, preferably by roughening, fast electrodeposition, or nodule-treating the current collector material. Nodule treatment is known in the art and can for example be performed by electrodeposition on copper foil in a solution containing dissolved CuSO₄ and/or NiSO₄ and/or other chemical additives. Current density, additive concentration, additive species and plating time can be varied to produce different structures of different size, such as small spheres.

Advantageously, according to the method of the invention, the method preferably comprises, prior to providing the current collector material, a step of adding an adhesion layer to the current collector material.

According to the invention, preferably the operating gas comprises a gas selected from a group comprising monosilane, disilane, trisilane, and chlorosilanes.

According to the invention, preferably the operating gas comprises an alloying compound, for forming a silicon alloy.

According to the invention, preferably the operating gas comprises a support gas comprising argon, helium, molecular nitrogen and/or molecular hydrogen.

Controlling the mixture, flow rate and/or pressure of an operating gas according to the invention preferably comprises controlling the ratio of the precursor gas to the support gas of from 0.05:1 to 5:1, preferably wherein the concentration molecular hydrogen in the support gas is of from 5 to 95% (mol/mol).

Controlling the mixture, flow rate and/or pressure of an operating gas according to the invention preferably comprises controlling the pressure of from 0.05 to 0.3 mbar.

Controlling the power input and/or frequency according to the invention preferably comprises controlling the power input with a power of from 800 to 6000 W or of from 800 to 6000 W/m. An antenna wire with a length of 1 m, which is used as a means or source of power, is thus controlled with regard to power input by providing power of from 800 to 6000 W. A deposition tool can have one or more antennas, each having their own supply of microwave power.

Controlling the power input and/or frequency according to the invention preferably comprises controlling the frequency with a frequency of from 300 MHz to 30 GHZ, preferably with a frequency of about 915 MHZ, about 2.45 GHz or about 5.8 GHz, or with a frequency comprising a frequency in the range of the C, L or S bands as set according to the Institute of Electrical and Electronics Engineers, or with a frequency of from 2.3 to 2.6 GHz.

Depositing silicon according to the method of the invention preferably comprises depositing silicon at a substrate temperature of from 120 to 300° C., more preferably of from 120 to 200° C.

Depositing silicon according to the method of the invention preferably comprises using physical vapor deposition (PVD) or chemical vapor deposition (CVD), more preferably plasma-enhanced CVD (PECVD), preferably wherein depositing silicon further comprises controlling the power input and/or frequency to a predetermined value to form the silicon layer. Preferably, using PECVD comprises creating plasma by generating electromagnetic waves via an antenna wire, preferably wherein each end of the antenna wire is coupled to a generator configured to generate electromagnetic waves. Depositing silicon according to the method of the invention preferably comprises using one or more means or sources of power input. Preferably, one means or source of power input is used to deposit silicon to form each individual silicon layer. Preferably, a different means or source of power input is each used to deposit silicon to form each individual silicon layer.

### DETAILED DESCRIPTION OF THE FIGURES

The invention will now be discussed with reference to the figures, which show preferred exemplary embodiments of the subject invention.

FIG. 1 shows schematic examples of composite electrode material according to the invention. Composite electrode 1A is optimized for cycle/C-rate. It has a very open structure to accommodate diffusion of lithium ions. On top of a copper current collector material layer (100) it comprises a bottom thin first silicon layer having a very low porosity (101) to promote adhesion. It comprises a second thin silicon layer having a higher porosity than the first layer with an intermediate porosity (102) that acts as a second adhesion layer. It comprises a top additional, third thick silicon layer having a high porosity (103) that is higher than the porosity of the second silicon layer. The silicon layers are organized as columnar structures (104) with large and wide major void structures between columns to promote diffusion of electrolyte comprising lithium.

Composite electrode 1B is optimized for Coulombic efficiency. On top of a current collector material layer (100) it comprises a bottom thin first silicon layer having a very low porosity (101) to promote adhesion. It comprises a second thick silicon layer (105) having a higher porosity than the first layer and a low specific surface area that acts as the major active silicon material. It comprises a top additional, third thin silicon layer having a very low porosity (106), lower than the second layer, that serves to reduce SEI formation inside the second layer (105). In addition, the width of the major void structures between the columnar structures is minimized in order for the top additional layer to be structured to substantially seal off the second layer. Therefore, while still present, the major void structures are not illustrated here.

Composite electrode 1C comprises on top of a current collector material layer (100) a bottom thin first silicon layer having a very low porosity (101) to promote adhesion. It comprises a second layer (107) having a higher average porosity than the first layer, while also having a gradient layer with a high porosity at a first surface area facing the first silicon layer gradually decreasing to a lower porosity at a second surface area opposite the first surface area. It comprises an additional, third thin silicon layer (108) having a different average porosity than the second layer (107). An additional, fourth silicon layer (109) having a higher porosity than the third layer is on top of the third layer (108). Three columnar structures with major void structures can be clearly discerned.

FIG. 2 shows a cross-sectional scanning EM image of a composite electrode material according to the invention. The distance between each of the small white lines on the top right of the image indicates 1 μm. Here, composite electrode 1B of FIG. 1 has been manufactured and subsequently imaged via scanning EM. On top of a sheet of roughened copper current collector material (100) a bottom first silicon layer with a very low porosity (101) and a thickness of about 200 nm is present. On top of the first layer, a second silicon layer with a higher porosity (105) with a thickness of about 15 to 20 μm is present. On top of the second layer, an additional layer having a very low porosity (106) with a thickness of about 1 μm is present. Major void structures (200) are present separating or interspersing the columnar structures (104) that extend in a substantially perpendicular direction from the surface plane of the current collector material (100). It can be seen that the major void structures seem to originate from irregularities present on the surface of the current collector material layer. A plurality of void structures having a mean width of from 1 to 10 nm (201) can be seen throughout the second layer (105).

FIG. 3 shows a cross-sectional scanning EM image of a composite electrode material according to the invention. A composite electrode according to the invention has been manufactured and subsequently imaged via scanning EM. On top of a sheet of roughened copper current collector material (100) a bottom first silicon layer with a very low porosity (101) and a thickness of about 2 to 3 μm is present. On top of the first layer, a second silicon layer with a very high porosity (110) with a thickness of about 3 to 4 μm is present. On top of the second layer, an additional layer having a low porosity (111) with a thickness of about 2 to 3 μm is present. Major void structures (200) are present separating or interspersing the columnar structures (104) that extend in a substantially perpendicular direction from the surface plane of the current collector material (100). It can be seen that the major void structures seem to originate from irregularities present on the surface of the current collector material layer. A plurality of void structures having a mean width of from 1 to 10 nm (201) can be seen throughout the second layer (110) and the additional third layer (111).

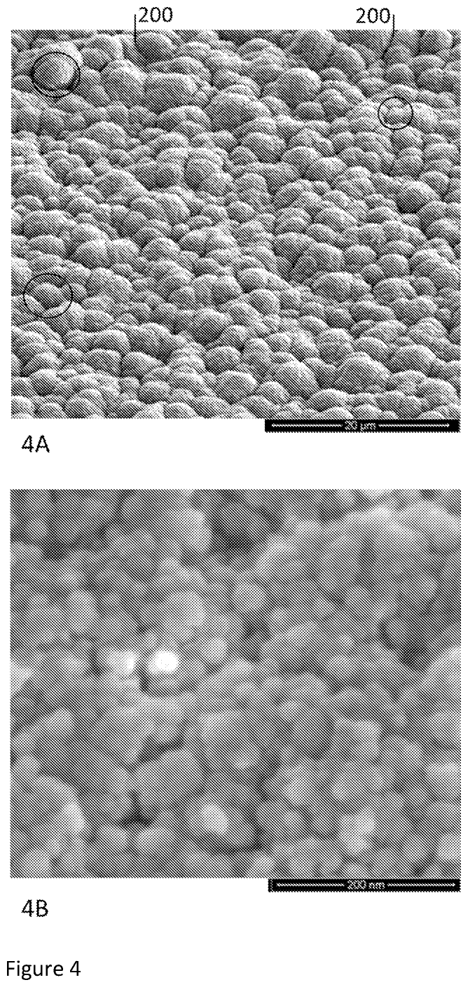

FIG. 4 shows top view scanning EM images of composite electrode material according to the invention. FIG. 4A shows a top view of the top silicon layer of the composite electrode material according to the invention. The top silicon layer can be the second silicon layer or an additional silicon layer. The tops of the columnar structures of the silicon layer are discernable as bulging, round, mushroom-like structures separated by surrounding black major void structures (200) throughout the image. Several tops of columnar structures are encircled. Here, the average diameter of the columnar structures is about 5 μm. FIG. 4B shows a higher magnification image of the same material of FIG. 4A. The top silicon layer comprises a plurality of particles. The particles seem to have a substantially spherical or spheroid shape.

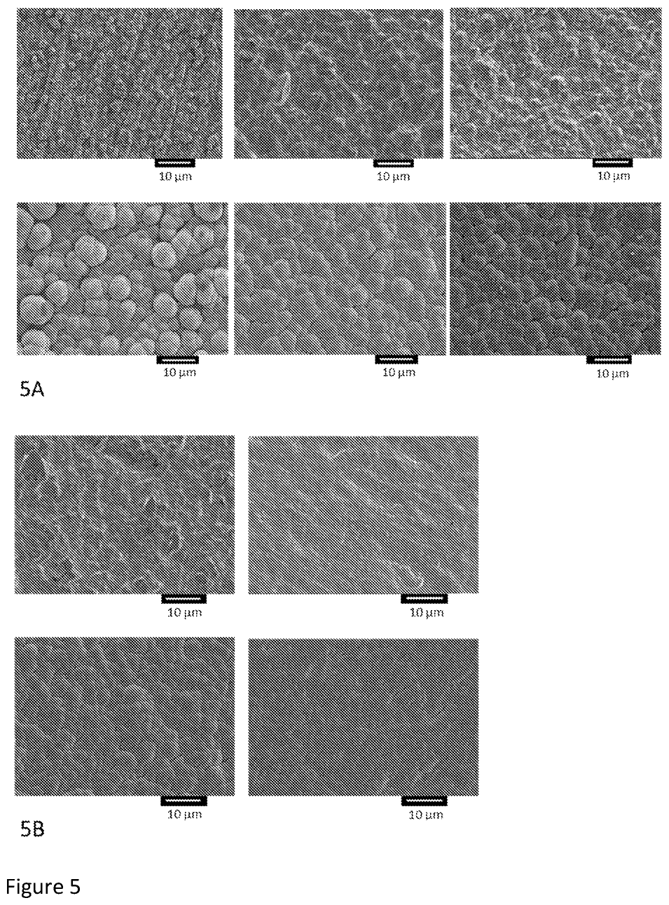

FIG. 5 shows top view scanning EM images of various current collector material copper foil structures and subsequently deposited silicon layers according to the invention. The white bar indicates 10 μm. FIGS. 5A and 5B show top views of either the roughened copper foil current collector material according to the invention (top row) before addition of a silicon layer, or a top view of the top silicon layer of the composite electrode material according to the invention (bottom row) that has been subsequently deposited according to the invention on a deposited first and optionally second silicon layer on the respective current collector material. The top silicon layer can be the second silicon layer or an additional silicon layer. The tops of the columnar structures of the silicon layer are discernable as bulging, round, mushroom-like structures separated by surrounding black major void structures throughout the image. Composite electrode material according to the invention having larger, more distinguished columnar structures with major void structures separating the columnar structures, such as those imaged in FIG. 5A, had improved anode properties, while those having less pronounced columnar structures, such as those imaged in FIG. 5B, had bad anode properties. For FIG. 5A, anode material of the left image had the best properties, material of the middle image had good properties, material of the right image had acceptable properties. For FIG. 5B, anode material of the left image had bad properties, material of the right image had very bad properties. Thus, the structure of the copper foil current collector material influenced the properties of the composite electrode material according to the invention. A low roughness or relatively flat texture of the current collector material seems to prevent the formation of acceptable composite electrode material according to the invention.

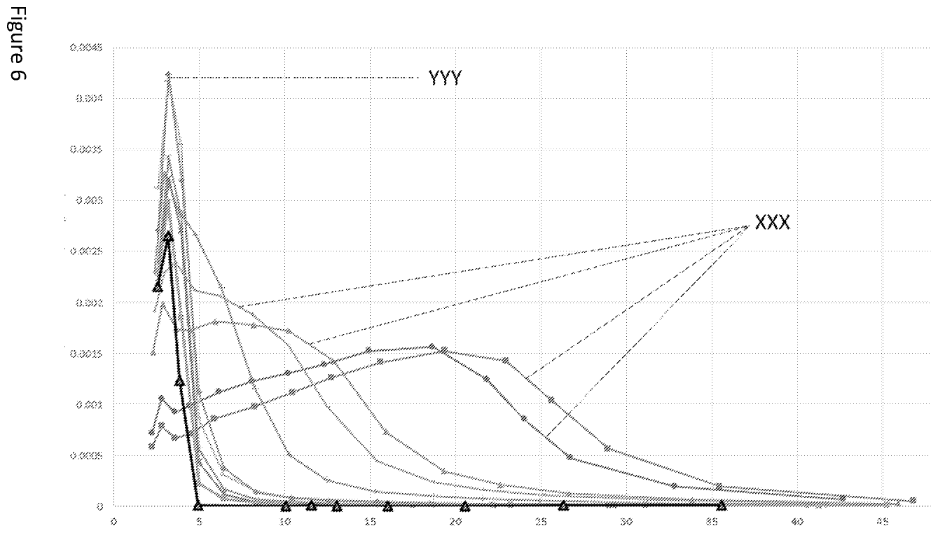

FIG. 6 shows the pore size or width and pore volume distribution of the electrode composite material according to the invention as determined by the Barrett-Joyner-Halenda (BJH) method pursuant to ISO 15901-2:2006. The x-axis indicates pore width (nm), the y-axis indicates dV/dw pore volume (cm³/g·nm). The four dashed lines linking “XXX” with the symbol-indicated lines relate to composite materials with a pore size distribution with an average pore size of greater than 5 nm, and are not preferred. Two of these dashed lines show pore size distributions with an average pore size of: 7.28 nm (triangles) and 10.84 nm (circles). The dashed line linking “YYY” with the diamond-indicated line relates to composite material with an average pore size distribution of 3.94 nm (diamonds), and is preferred. This figure indicates that different structures can be achieved by changing process parameters.

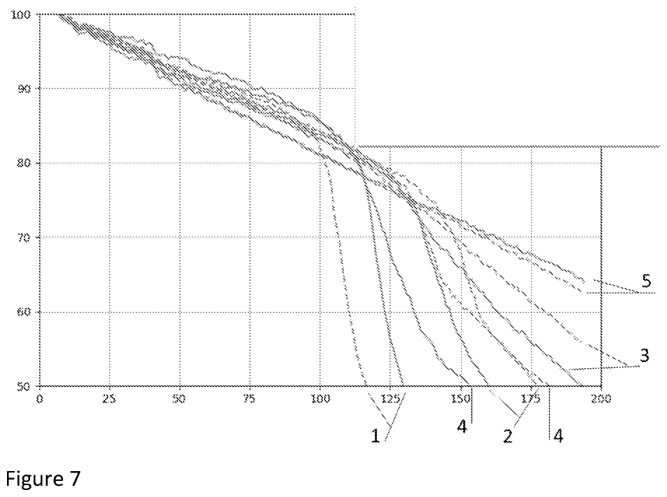

FIG. 7 shows the capacity retention of a coin full cell battery comprising the electrode material according to the invention over multiple charge-discharge cycles. The x-axis indicates the number of charge-discharge cycles, the y-axis indicates capacity retention (% compared to cycle 1 set to 100%). The numbers (and the lines connecting the numbers to the lines of the graph) indicate the different composite electrode materials as described in Example 2 and Table 2.

FIG. 8 shows a graphical representation of the Sdq and Sdr values of Table 1. FIG. 8A represents Sdq and FIG. 8B represents Sdr. The x-axis shows current collector material copper foil sheets 1 to 14. The y-axis shows respective Sdq and Sdr roughness values. Current collector material copper foil sheets 1 to 7, exhibiting a surface roughness value Sdr greater than 40% or Sdq greater than 1.0 resulted in composite electrode material according to the invention having a good performance, while current collector material copper foil sheets 8 to 14, resulted in composite electrode material having an inferior performance.

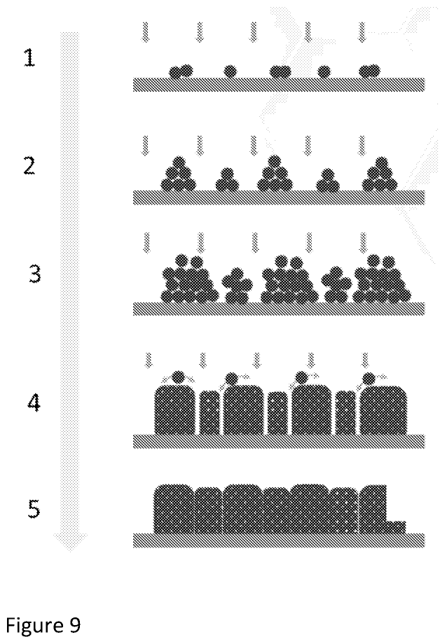

FIG. 9 shows an illustration of the deposition of silicon according to the method of the invention resulting in the silicon layers and the composite electrode material according to the invention, comprising columnar structures. Small clusters of amorphous silicon are formed by gas phase reaction. The silicon is deposited with a process called ballistic growth, in which particles move towards the substrate and adhere to it. From top to bottom five sequential phases of deposition are illustrated. In phase 1, silicon (represented by the circles) is seed deposited from above (represented by the arrows) on the current collector material according to the invention (represented by the rectangle). In phase 2, more silicon is deposited resulting in nucleation of the silicon. In phase 3, more silicon is deposited resulting in island formation of the silicon. In phase 4, more silicon is deposited resulting in coalescence of the silicon and the beginning of the formation of the columnar structures according to the invention. In phase 5, the final structure of the silicon layer is illustrated comprising the columnar structures and major void structures according to the invention.

The present invention is now further described with reference to the following non-limiting examples.

### Example 1

Different current collector materials consisting of a copper foil sheet were obtained from various suppliers. The copper foil sheets had been treated by roughening the surface by various known methods, resulting in sheets with different roughness values and textures. Fourteen different commercially available copper foils were assessed. Surface roughness or texture values were determined using white light interferometry according to the method pursuant to the standard method ISO 25178 (2012).

First and second silicon layers were deposited on one side of the treated copper foil sheets by PECVD according to the invention, thereby generating composite electrode material according to the invention.

Briefly, the composite electrode material was manufactured as follows. A roll roughened copper foil current collector material was fed into a deposition device that comprises an unwinding chamber, two deposition chambers and a rewinding chamber. These chambers are all connected and are normally operated under vacuum (0.05-0.2 mbar). The foil was transported by a system of tension rolls and two heated drums that will control the temperature of the foil. A first and at least a second silicon layer were deposited onto the substrate by plasma enhanced chemical vapor deposition, at a substrate temperature of from 100 to 300° C. In this process magnetron radiation with a frequency of 2.45 GHz was used to excite a gas mixture containing a silicon precursor gas and support gases. Silane (SiH₄) was the source of silicon, whereas argon (Ar) and hydrogen (H₂) were added to stabilize the plasma, influence the material structure and improve the deposition rate. The gas was injected via “gas showers” that distribute the gas evenly.

The magnetron radiation was introduced into the vacuum chamber by means of an antenna. To make the plasma homogeneous, both sides of the antenna are connected to a magnetron radiation source. Magnetron heads are thus located on each side. These magnetron heads are connected to the antenna. Gases are injected via the gas showers between the magnetron heads. The antenna is protected from the reactive environment by a quartz tube. The plasma is confined by a magnetic field that is generated by an array of permanent magnets.

The production rate of silicon was determined by the process conditions, power input per source, and by the number of microwave sources in operation. The gas flow was scaled with the MW power input, which was 800-6000 W/m. Ten antennas or sources of power input were used.

The manufactured composite electrode material as described above was used in the manufacture of a standard CR2032 coin cell, comprising an electrolyte, a cathode, a separator and the manufactured composite material. Performance of the batteries was assessed by measuring the cycling capacity retention as a function of the number of cycles and the results are indicated in Table 1, wherein “−” indicates a bad performance and “+” indicates a good performance.

TABLE 1
Results of performance assessment of batteries comprising
composite electrode material according to the invention
comprising different current collector materials having
different roughness or texture values. Surface roughness
or texture values were determined by white light interferometry
according to standard method ISO 25178(2012).

| Current | | | | | | | | |
|---|---|---|---|---|---|---|---|---|
| collector | Sa | Sq | Sz | Sds | Ssc | | Sdr | Perfor- |
| material | μm | μm | μm | 1/μm² | 1/μm | Sdq | % | mance |
| 1 | 0.51 | 0.65 | 5.9 | 0.77 | 16.2 | 2.1 | 157 | + |
| 2 | 1.31 | 1.59 | 10.9 | 0.44 | 12.3 | 2.9 | 290 | + |
| 3 | 0.61 | 0.85 | 8.1 | 0.52 | 9.5 | 2.1 | 165 | + |
| 4 | 0.52 | 0.66 | 7.2 | 0.57 | 11.8 | 1.7 | 106 | + |
| 5 | 0.61 | 0.78 | 6.4 | 0.55 | 11.1 | 2.3 | 199 | + |
| 6 | 0.43 | 0.56 | 6.1 | 0.60 | 10.8 | 2.1 | 163 | + |
| 7 | 0.39 | 0.49 | 5.9 | 0.65 | 11.8 | 2.1 | 155 | + |
| 8 | 0.32 | 0.39 | 3.5 | 0.28 | 6.1 | 0.7 | 19 | − |
| 9 | 0.23 | 0.31 | 3.8 | 0.36 | 7.9 | 1.0 | 34 | − |
| 10 | 0.17 | 0.24 | 3.6 | 0.34 | 6.6 | 0.8 | 24 | − |
| 11 | 0.13 | 0.2 | 2.9 | 0.30 | 5.1 | 0.7 | 17 | − |
| 12 | 0.49 | 0.59 | 4.1 | 0.41 | 7.5 | 0.9 | 33 | − |
| 13 | 0.2 | 0.27 | 4.1 | 0.32 | 6.9 | 0.8 | 26 | − |
| 14 | 0.22 | 0.31 | 3.9 | 0.33 | 7.5 | 0.9 | 30 | − |

It was found that using current collector material copper foil sheets 1 to 7, exhibiting a surface roughness value or texture with an Sz greater than 5.0 μm, an Sds greater than 0.41, an Ssc greater than 8.0, an Sdr greater than 40% or an Sdq of greater than 1.0 resulted in composite electrode material having a good performance, while using current collector material copper foil sheets 8 to 14, resulted in composite electrode material having an inferior performance.

### Example 2

Various composite electrode materials according to the invention were manufactured according to the method of the invention. First and second silicon layers were deposited on one side of the treated copper foil sheets by PECVD according to the invention, thereby generating composite electrode material according to the invention as described by the manufacture method in Example 1. The manufactured composite electrode material was used in the manufacture of a CR2032 full coin cell, comprising an electrolyte, a cathode, a separator and the manufactured composite material. Performance of the batteries was assessed by determining capacity retention over multiple charge and discharge cycles. The results are illustrated in FIG. 7 and specific properties of the various composite electrode materials of the batteries are indicated in Table 2. Reduction of the capacity retention occurred mostly due to structural collapse (e.g. fractures in or delamination of the silicon) or electrolyte malfunction (e.g. SEI consumption). It was found that composite electrode materials comprising a specific surface area of from 109 to 129 m²/g, an average pore size of from 5.1 to 12.5 nm or a second silicon layer porosity of from 32 to 44% produced suboptimal results with regard to capacity retention over multiple cycles. These results are not illustrated in FIG. 7 or Table 2. For the exemplified batteries illustrated in FIG. 7 and Table 2 it was thus found that the best results were achieved when the composite electrode material comprises a silicon layer comprising pores having a mean pore size or width of from 3 to 5 nm, or wherein the second silicon layer has a porosity of from 6 to 18%, or wherein the silicon layer has a specific surface area of from 30 to 90 m²/g.

TABLE 2
Results of performance assessment of batteries comprising
composite electrode material according to the invention comprising
different specific surface areas, mean pore sizes and porosities.

| Composite electrode | Specific surface | Mean | |
|---|---|---|---|
| material | area | pore size | Porosity |
| 1 | 50 | 3.6 | 9.6 |
| 2 | 61 | 3.7 | 11.6 |
| 3 | 83 | 3.9 | 16 |
| 4 | 73 | 3.8 | 14 |
| 5 | 83 | 3.9 | 16 |

### Example 3—Delamination Test

Different commercially available current collector materials consisting of a copper foil sheet were obtained. The copper foil sheets had been treated by roughening the surface by various known methods, resulting in sheets with different roughness values and textures. Two different commercially available copper foils were assessed. Surface roughness or texture values were determined using white light interferometry according to the method pursuant to the standard method ISO 25178 (2012).

First and second silicon layers were deposited on one side of the treated copper foil sheets by PECVD according to the invention, thereby generating composite electrode material according to the invention. The composite electrode material was manufactured as in Example 1. The results of a delamination test are reproduced in the table below. As can be seen from the table the example according to the invention in which the features of the surface roughness of the current collector layer Sdr and Sdq are according to the invention exhibited the technical effect of resistance to delamination. In comparison, the comparative current collector material in which the features of the surface roughness of the current collector layer Sdr and Sdq are not according to the invention exhibited delamination. Delamination is a problem in battery materials, as fracturing, crumbling or delamination of the silicon material from the anode reduce the charge capacity of the anode and reduce the charge cycle life of a cell comprising such an anode.

TABLE 3
Results of delamination tests conducted on (i) a material
composite electrode material according to the invention;
and (ii) a comparative composite electrode material
not according to the invention.

| Composite | | | |
|---|---|---|---|
| electrode material | Sdr | Sdq | Delamination |
| 15 | 83 | 2.08 | No |
| Comparative A | 15 | 0.71 | Yes |

1. A composite electrode material comprising:
i) a current collector material layer exhibiting a surface roughness value selected from at least one of the following:
an Sdr value of more than 40%; and
an Sdq value of more than 1.0; each value being determined by white light interferometry according to standard method ISO 25178; and
ii) multiple silicon layers, comprising at least a first silicon layer positioned on the current collector material layer.

2. The composite material according to claim 1, wherein the silicon layers are comprised of at least 99% by weight of silicon.

3. The composite material according to claim 1, comprising at least a first silicon layer having a porosity of less than 30%, as determined by electron microscopy, and at least a second silicon layer positioned on the first silicon layer, wherein the second silicon layer has a porosity ranging from a porosity higher than the porosity of the first layer, to a porosity of less than 80%, as determined by electron microscopy.

4. (canceled)

5. The composite material according to claim 3, further comprising an additional silicon layer positioned on top of the first or second silicon layer, and optionally one or more additional silicon layers each in turn positioned on a respective directly underlying additional silicon layer, wherein each additional silicon layer has a porosity different from the porosity of the second silicon layer and/or each of the respective directly underlying additional silicon layer.

6. The composite material according to claim 3, wherein the at least second silicon layer comprises a plurality of void structures having a mean width of from 1 to 10 nm, and/or wherein the at least second silicon layer comprises a plurality of major void structures having a mean width of from 10 nm to 150 nm.

7. The composite material according to claim 6, wherein the major void structures have an orientation with a substantially perpendicular angle to the surface plane of the current collector material.

8. The composite material according to claim 1, wherein the first, second and/or additional silicon layer(s) comprise a plurality of columnar structures, the columnar structures extending in a substantially perpendicular direction from the surface plane of the current collector material.

9. (canceled)

10. The composite material according to claim 1, wherein the first, second and/or additional silicon layer(s) comprise a plurality of aggregated particles, wherein the particles have pores, wherein the pores have a mean pore size or width of from 2.5 to 5 nm as determined by the Barrett-Joyner-Halenda (BJH) method pursuant to ISO 15901-2:2006.

11. The composite material according to claim 10, wherein the pores have a size or width distribution mode of from 1 to 5 nm, as determined by the Barrett-Joyner-Halenda (BJH) method pursuant to ISO 15901-2:2006.

12. The composite material according to claim 1, wherein the composite material comprises the first, second and/or the additional silicon layer(s) on only one side of the current collector material or on each of two sides of the current collector material.

13. (canceled)

14. The composite material according to claim 1, wherein the current collector material exhibits a surface roughness value selected from at least one of the following:
an Sz value of more than 5.0 μm;
an Sds value of more than 0.41; and
an Ssc value of more than 8.0; each value being determined by white light interferometry according to standard method ISO 25178.

15. The composite material according to claim 1, wherein the current collector layer comprises a metal adhesion layer having a thickness of from 0.1 to 5 nm, comprising a metal, metal alloy and/or metal salts and/or oxide, wherein the metal, metal alloy and/or metal salts and/or oxide are selected from aluminium, copper, nickel, tin, indium and zinc.

16. The composite material according to claim 1, wherein the first silicon layer and/or second silicon layer comprises a plurality of adjacent columns extending in a perpendicular direction from the current collector layer.

17. (canceled)

18. (canceled)

19. (canceled)

20. The composite material according to claim 16, wherein the silicon columns comprise dendritic or multibranch silicon columns.

21. The composite material according to claim 16, wherein the spatial distribution or arrangement of the plurality of silicon columns is a substantially random distribution across the current collector layer.

22. The composite material according to claim 16, wherein the adjacent columns further comprise a silicon alloy.

23. (canceled)

24. (canceled)

25. (canceled)

26. (canceled)

27. (canceled)

28. The composite material according to claim 16, wherein the adjacent columns have an average footprint of 0.25 to 0.5 μm², along the surface of the current collector layer.

29. A method for producing the composite electrode material of claim 1, comprising the following steps:
a. providing a current collector material exhibiting a surface roughness value selected from at least one of the following: an Sdr value of more than 40% and an Sdq value of more than 1.0; each value being determined by white light interferometry according to standard method ISO 25178;
b. optionally, depositing silicon on the current collector current collector material, comprising providing an operating gas comprising a precursor gas comprising silicon to whereby the mixing ratio, flow rate and/or pressure of the operating gas are controlled at a first predetermined value, to form a first silicon layer, wherein the first silicon layer has a porosity of less than 30%, as determined by electron microscopy; and
c. depositing a further silicon on the current collector material or the first silicon layer obtained in b., comprising providing an operating gas comprising a precursor gas comprising silicon to whereby the mixing ratio, flow rate and/or pressure of the operating gas are controlled at a second predetermined value, to form at least a second silicon layer, wherein the second silicon layer has a porosity ranging from a porosity higher than the optional first silicon layer, to a porosity of less than 80%, as determined by electron microscopy.

30.-36. (canceled)

37. A battery comprising an electrolyte, a cathode, a separator and the composite material according to claim 1.

38. (canceled)

39. The method according to claim 29, comprising a step d. of depositing silicon on the at least second silicon layer, comprising providing an operating gas comprising a precursor gas comprising silicon to whereby the mixing ratio, flow rate and/or pressure of the operating gas are controlled at a further predetermined value to form an additional silicon layer, wherein the additional silicon layer has a porosity different from the porosity of the second silicon layer, and optionally comprising a step e. of repeating step e., wherein an additional silicon layer has a porosity different from the porosity of each directly underlying additional silicon layer.
